(19) United States
(12) Patent Application Publication
(10) Pub. No.: US 2004/0187625 A1
(43) Pub. Date: Sep. 30, 2004

(54) Actuating pedal for motor vehicles

(76) Inventors: Lothar Schiel, Hofheim (DE); Andreas Schirling, Pfungstadt (DE); Johannes Gorlach, Langgons (DE); Lars Lucius, Darmstadt (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/492,374

(22) PCT Filed: Oct. 9, 2002
(86) PCT No.: PCT/EP02/11304

(30) Foreign Application Priority Data
Oct. 12, 2001 (DE) 101 50 588.4

(51) Int. Cl. G05G 1/14

(52) U.S. Cl. 74/514

(57) ABSTRACT

The invention relates to an actuating pedal for motor vehicles that is rotatably mounted by means of a pivot axis and includes a sensor device which picks up the pedal travel. According to the invention, the sensor device is comprised of an encoder member and at least two magnetically sensitive sensing elements cooperating with the encoder member.

### TECHNICAL FIELD

The present invention generally relates to an actuating pedal for motor vehicles and more particularly relates to an actuating pedal for motor vehicles that is rotatably mounted by means of a pivot axis and includes a sensor device which picks up the pedal travel.

### BACKGROUND OF THE INVENTION

An actuating pedal of this type is generally disclosed in international patent application WO 01/40039 A1. With this prior art actuating pedal, the sensor device is configured as an inductive sensor with a stationary coil member and a metal member moved with the pedal in such a manner that variations of the distance between coil member and metal member will take influence on the electrical conditions from which corresponding measured values are derived.

The sensor device for detecting the angular position operates according to an analog measuring principle. The relatively low resolution of the sensor signal is disadvantageous. Further, a highly accurate mounting support of the pedal is necessary because inaccuracies of the pedal mounting support will otherwise have a direct effect on the result of measurement or abrupt variations of measured values can occur. The susceptibility of the inductive sensor to interferences caused by metal foreign bodies can be considered another shortcoming. For the above-cited reasons, the prior-art actuating pedal is inappropriate for the actuation of electric vehicle systems, for example, for a brake system of the ‘brake-by-wire’ type.

### BRIEF SUMMARY OF THE INVENTION

In view of the above, an object of the present invention is to disclose an actuating pedal of the above-mentioned type whose sensor has a measuring range with a higher resolution and, thus, furnishes very exact measured values.

This object is achieved by the invention in that the sensor device is comprised of an encoder member and at least two magnetically sensitive sensing elements cooperating with the encoder member.

To render the idea of the invention more precise, the encoder member includes an absolutely measurable first range and a second range of high resolution, wherein the first sensing element is configured as a sensor that detects absolute values and the second sensing element is configured as a sensor with incremental measurement. The use of an absolutely measuring sensor ensures an absolutely lasting position detection, which is indispensable especially in the actuation of electromechanically operable brake systems.

### BRIEF DESCRIPTION OF THE DRAWINGS

FIG. 1 is a side view of a first embodiment of the actuating pedal of the invention.

FIG. 2 is a side view of a second embodiment of the actuating pedal of the invention.

FIG. 3 is a schematic view of another embodiment of the encoder member.

### DETAILED DESCRIPTION OF THE PREFERRED EMBODIMENTS

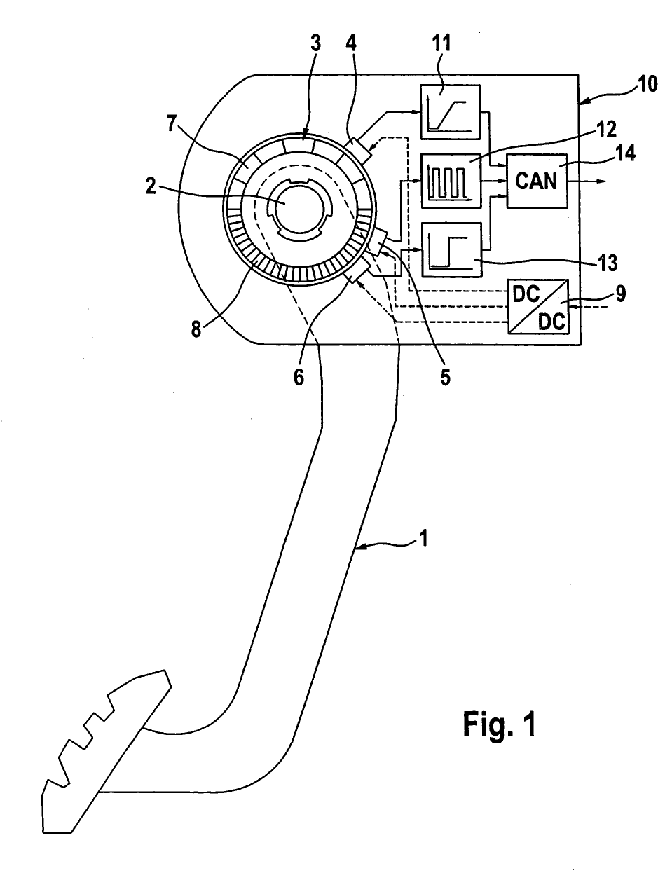

The actuating pedal 1 illustrated in FIG. 1 is mounted by means of a pivot axis 2 in a carrier (not shown) in the leg room of a motor vehicle, and a sensor device 10 is provided for detecting the position of the actuating pedal 1. The sensor device 10 in the illustrated embodiment is formed of a circular encoder member 3 that is disposed in the range of attachment of the brake pedal 1 on the pivot axis 2 and kinematically coupled to the actuating pedal 1, as well as three magnetically sensitive sensing elements 4, 5 and 6. A current supply circuit (shown only schematically) for the sensing elements 4-6 is designated by reference numeral 9. The electric measured variables of the sensing elements 4-6 are sent to each one evaluating unit 11, 12, 13, and the output signals of the evaluating units 11-13 are converted in a bus module 14 into a bus enabled signal. The encoder member 3 includes a first magnetic range 7 (encoder track) and a second magnetic range 8, and the pole distance (pole width) of the first range 7 corresponds to the maximum adjustment range of the actuating pedal 1. The second range 8 is formed of several magnet segments arranged side by side, whose pole distance is considerably shorter compared to the pole distance of the first range 7. The first sensing element 4 which can be designed as a magnetoresistive sensor or Hall sensor executes an absolute measurement of the position of the actuating pedal 1 and permits an absolutely lasting position detection due to the relatively large pole distance of the first range 7. The second sensing element 5 which can also be designed as a magnetoresistive sensor carries out an incremental or relative measurement of the position of the actuating pedal 1 and can display the second range 8 with a higher resolution due to the high signal-to-noise ratio of its output signals. The third sensing element 6 associated with the second range 8 and also configured as a magnetoresistive sensor is especially used in actuating pedals used for the actuation of electrically operable, so called ‘brake-by-wire’ brake systems where it fulfils a system alarm function. The resolution of the alarm sensor 6 is, however, much more coarse-grained than the resolution of the sensor 5 with incremental measurement. On the other hand, its current consumption ranges far below 100 μA so that it can be operated constantly. To safeguard high precision of the measurement result of the sensor device 10, it is especially favorable that in the evaluation of the electric measured variables of the sensing elements 4-6 in the electronic evaluating units 11-13, the output signals of the first sensing element 4 are subjected to a signal conditioning operation and the output signals of the second sensing element 5 are subjected to interpolation. The maximum resolution of the second range 8 is achieved by the last mentioned measure.

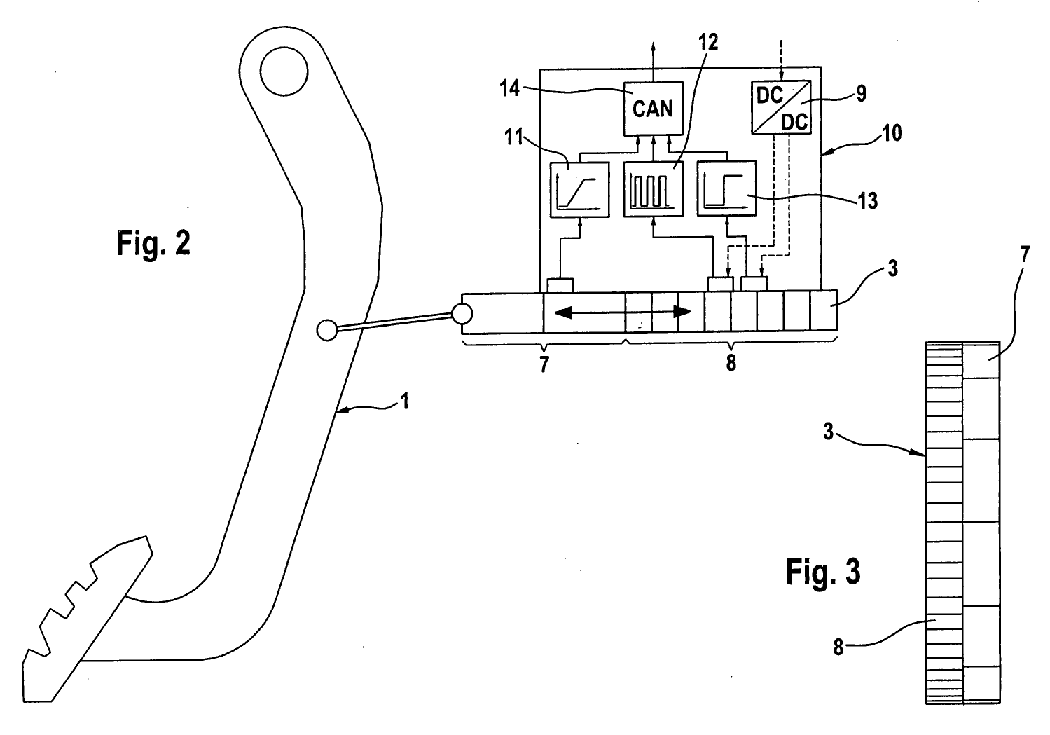

In the second embodiment of the pedal assembly of the invention illustrated in FIG. 2, the encoder member has a strip-shaped design, and its magnetic ranges or encoder tracks 7, 8 are arranged one behind the other. The position of the sensing elements 4-6 is also adapted to the mentioned arrangement of the magnetic ranges 7, 8. The encoder member is coupled to the actuating pedal 1 in such a manner that a swinging movement of the actuating pedal 1 is converted into a translational motion of the encoder member. The signals of the sensing elements are evaluated or further processed in the way explained with respect to the first embodiment.

The third design of the encoder member 3 shown in FIG. 3 is also strip-shaped, and its magnetic ranges or encoder tracks 7, 8 are arranged side by side.

Various modifications are feasible within the limits of the invention. Thus, it is e.g. possible to realize a brake light switch function. The first switching pulse of the third sensing element 6 is used for this purpose.

1-16 (Canceled)

17. Actuating pedal assembly for motor vehicles, comprising:
a pedal,
a sensor device for detecting movement of the pedal, wherein the sensor device includes an encoder member and first and second, magnetically sensitive, sensing elements cooperating with the encoder member.

18. Actuating pedal assembly as claimed in claim 17, wherein the encoder member includes an absolutely measurable first range and a second range of high resolution, wherein the first sensing element is configured as a sensor that detects absolute values and the second sensing element is configured as a sensor with incremental measurement.

19. Actuating pedal assembly as claimed in claim 17, wherein the encoder member has a circular or circle-segment-shaped design.

20. Actuating pedal assembly as claimed in claim 17, wherein the encoder member has a strip-shaped design.

21. Actuating pedal assembly as claimed in claim 20, wherein the magnetic ranges of the encoder member are arranged one behind the other.

22. Actuating pedal assembly as claimed in claim 20, wherein the magnetic ranges of the encoder member are arranged side by side.

23. Actuating pedal assembly as claimed in claim 17, wherein the sensing elements are configured as magnetoresistive sensing elements.

24. Actuating pedal assembly as claimed in claim 17, wherein the encoder member is coupled to the brake pedal, while the sensing elements are mounted on a stationary carrier that is preferably used for the mounting support of the pivot axis.

25. Actuating pedal assembly as claimed in claim 24, wherein the encoder member is positively engaged with the brake pedal.

26. Actuating pedal assembly as claimed in claim 18, wherein the first range has a first pole width corresponding to the maximally attainable pedal travel.

27. Actuating pedal assembly as claimed in claim 18, wherein the second range has a second pole width being considerably smaller than the first pole width.

28. Actuating pedal assembly as claimed in claim 18, further including means for generating electric values from the first and second sensing element and means for signal conditioning said electric values.

29. Actuating pedal assembly as claimed in claim 28, wherein the electric measured values of the second sensor are subjected to an interpolation.

30. Actuating pedal assembly as claimed in claim 17, further including a ‘brake-by-wire’ type, brake system coupled to said sensor device, wherein a third sensing element cooperates with the second range for activating the brake system.

31. Actuating pedal assembly as claimed in claim 17, wherein the first and the third sensing element are designed as Hall effect sensors.

32. Actuating pedal assembly as claimed in claim 31, wherein the third sensing element is configured as a Wiegand wire.
